(19) United States
(12) Patent Application Publication
(10) Pub. No.: US 2025/0276637 A1
(43) Pub. Date: Sep. 4, 2025

(54) METHODS AND SYSTEMS FOR CONTROLLING VEHICLE LIGHTING

(71) Applicant: J.B. Poindexter & Company, Houston, TX (US)

(72) Inventors: Adam Barry, Houston, TX (US); Andy Sutherland, Houston, TX (US)

(21) Appl. No.: 19/069,827

(22) Filed: Mar. 4, 2025

Related U.S. Application Data
(60) Provisional application No. 63/561,088, filed on Mar. 4, 2024.

(51) Int. Cl. B60Q 3/74; B60Q 3/16; B60Q 3/78; B60R 22/48; G07C 5/00; G07C 5/08; H05B 47/155

(52) U.S. Cl. CPC B60Q 3/74; B60Q 3/16; B60Q 3/78; G07C 5/004; G07C 5/0825; H05B 47/155; B60Q 2500/30; B60R 22/48

(57) ABSTRACT

Methods and systems are described that are configured for producing one or more lighting patterns via one or more linear lighting devices of a vehicle. A vehicle may include one or more linear lighting devices at one or more locations of the vehicle. Status information may be determined for the vehicle. One or more conditions associated with the vehicle may be determined based on the status information. Based on the one or more conditions, one or more lighting patterns may be output via the one or more linear lighting devices.

### CROSS-REFERENCE TO RELATED APPLICATION

This application claims priority to and the benefit of the filing date of U.S. Provisional Patent Application No. 63/561,088, filed Mar. 4, 2024, the entirety of which is hereby incorporated by reference herein.

### BACKGROUND

Vehicle lighting systems have traditionally served basic functions such as illuminating the road ahead and signaling turns or braking to other drivers. However, as vehicles have become more technologically advanced, there is an increasing need for more sophisticated lighting capabilities that can convey a wider range of information to drivers and passengers. Conventional vehicle lighting systems are limited in their ability to communicate complex status information or alerts in an intuitive way. Dashboard indicator lights and basic exterior lighting patterns lack the flexibility to convey nuanced information about vehicle systems, navigation, or environmental conditions. This can lead to information overload for drivers who must interpret multiple discrete indicators simultaneously. Additionally, standard vehicle lighting is not well-suited for providing ambient information that enhances situational awareness without distracting from the primary task of driving. Subtle lighting cues that operate in the driver's peripheral vision could potentially communicate useful information without requiring direct focus. Current vehicle lighting also does not take full advantage of modern LED technology and control systems. Most lighting elements are limited to basic on/off functionality rather than variable brightness, color, and pattern capabilities. This restricts the range of information that can be conveyed through lighting. Furthermore, existing lighting systems typically operate independently rather than as an integrated system responsive to the overall status of the vehicle and its surroundings.

Conventional interior lighting systems of vehicles include a lighting source disposed in the ceiling of the vehicle, emitting essentially white light. Sometimes, additional light sources are included in the vehicle, for instance at the level of a rear seat bench or in the trunk. The interior lighting provides better orientation for persons getting in or out of the car as well as during loading and unloading of the vehicle. It is usually activated by the opening of a vehicle door, or by a central locking system of the vehicle with the aid of a control unit. The interior lighting comes on in response to a vehicle door being opened. After the door is closed, the interior lighting is turned off, directly or by a time delay, or by the starting of the engine. These interior lighting systems may also include other lighting sources, such as a display screen or an instrument cluster, which are not used to illuminate the interior and may typically remain active when the interior lighting is turned off. The brightness and/or color of these lighting sources may be manually adjusted. Other lighting sources may include door handles and/or cigarette lights that are coupled to an activation of a vehicle's exterior lights. In addition, ambient lighting has been used in vehicles as a means for esthetic improvement of the passenger compartment of the vehicle and for highlighting the contours of the passenger compartment in the context of a particular design concept.

Navigation devices for vehicles are typically used to assist the driver of the vehicle while traveling to an input destination. These navigation devices are typically designed to supply acoustic and/or optic driving instructions to the driver at certain waypoints of a planned route, which indicate, for example, when to make a turn or to drive along a certain track. The driver receives instructions about how the motor vehicle has to be steered in the current driving situation, in order to follow the planned route, and provides the information regarding the direction of the destination.

However, these conventional interior lighting systems and navigation devices suffer from a number of disadvantages. For example, most of the lighting sources are only activated in connection with the opening of a vehicle door and are turned off by the closing of the door, or by a brief delay, so that the interior remains dark during the predominant part of the actual vehicle operation. Moreover, these lighting systems and navigation devices provide no meaningful way of conveying signals to the driver of the vehicle associated with a status of the vehicle without the driver having to take his/her eyes off of the road in front of him/her.

### SUMMARY

It is to be understood that both the following general description and the following detailed description are exemplary and explanatory only and are not restrictive.

Methods, systems, and apparatus for producing one or more light patterns via one or more linear lighting devices of a vehicle are described. A vehicle may include one or more linear lighting devices at one or more locations of the vehicle. Status information may be determined for the vehicle. The status information may be used to determine one or more conditions associated with the vehicle. Based on the one or more conditions, one or more lighting patterns may be output via the one or more linear lighting devices.

In an embodiment, disclosed is a vehicle lighting system comprising one or more linear lighting devices affixed to one or more locations of the vehicle, and one or more sensor devices affixed to the vehicle, wherein the one or more sensor devices are configured to determine status information associated with the vehicle, a computing device in communication with the one or more linear lighting devices and the one or more sensor devices, wherein the computing device is configured to receive the status information, determine, based on the status information, one or more conditions associated with the vehicle, generate, based on the one or more conditions, one or more signals for controlling the one or more linear lighting devices to output one or more lighting patterns, and cause, based on the one or more signals, the one or more linear lighting devices to output the one or more lighting patterns.

In an embodiment, disclosed is a lighting control system for a vehicle comprising a status information receiver configured to receive status information from one or more sensor devices associated with the vehicle, a condition determiner configured to determine one or more conditions associated with the vehicle based on the received status information, a lighting pattern generator configured to generate one or more lighting patterns based on the determined one or more conditions, and a lighting control signal generator configured to generate one or more control signals for controlling one or more linear lighting devices to output the one or more lighting patterns.

In an embodiment, disclosed are methods comprising receiving, by a device of a vehicle, from one or more sensors of the vehicle, status information associated with the vehicle, determining, based on the status information received from the one or more sensors, one or more conditions associated with the vehicle, generating, based on the one or more conditions, one or more signals for controlling one or more linear lighting devices to output one or more lighting patterns, and cause, based on the one or more signals, the one or more linear lighting devices to output the one or more lighting patterns.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

To easily identify the discussion of any particular element or act, the most significant digit or digits in a reference number refer to the figure number in which that element is first introduced.

FIG. 1 shows an example system;

FIG. 2A shows an example linear lighting device;

FIG. 2B shows an example system configuration;

FIG. 2C shows an example system configuration;

FIGS. 3A-3D show example system configurations;

FIG. 4 show an example process;

FIG. 5 shows a flowchart of an example method;

FIG. 6 shows a block diagram of a vehicle lighting system, according to aspects of the present disclosure;

FIG. 7 shows a block diagram of a condition-based lighting control system, according to an embodiment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Hereinafter, various embodiments of the present disclosure will be described with reference to the accompanying drawings. As used herein, the term “user” may indicate a person who uses an electronic device.

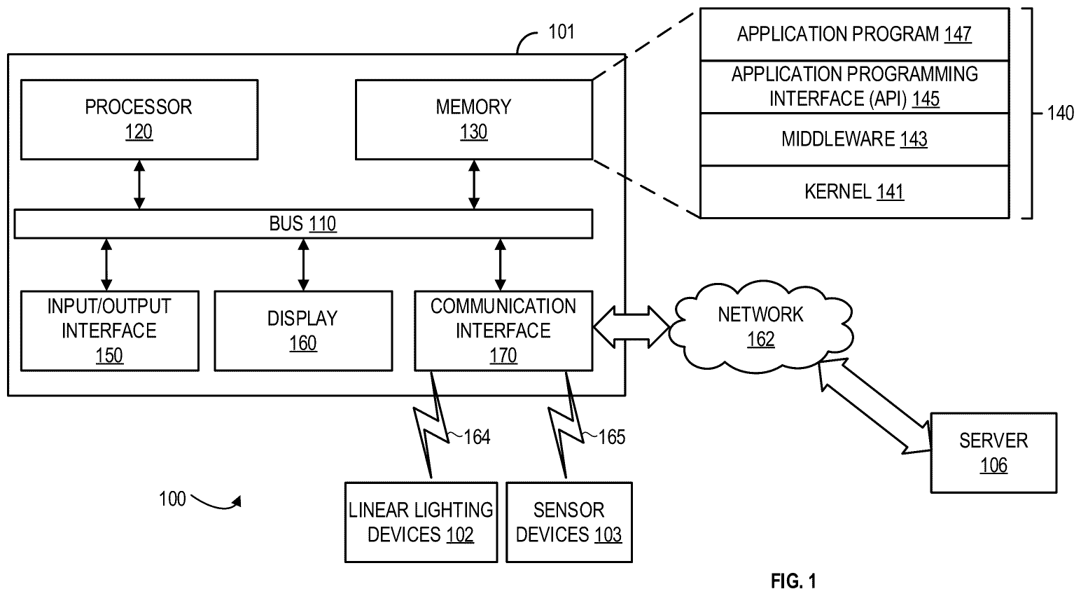

FIG. 1 shows an example system 100 including a vehicle computing device 101 configured for controlling one or more electronic devices (e.g., linear lighting devices 102 and/or sensor devices 103) of a vehicle according to various embodiments. The vehicle computing device 101 may be included in a vehicle (e.g., automobile, truck, SUV, electric vehicle, etc.). Optionally, in exemplary aspects, the vehicle may be a delivery vehicle (e.g., delivery van or delivery truck), a work truck, or other commercial vehicle. The vehicle computing device 101 may include a bus 110, a processor 120, a memory 130, an input/output interface 150, a display 160, and a communication interface 170. In an example, the electronic device 101 may omit at least one of the aforementioned constitutional elements or may additionally include other constitutional elements. The vehicle computing device 101 may comprise one or more of a telematics device, an electronic control device, and the like.

The bus 110 may include a circuit for connecting the processor 120, the memory 130, the input/output interface 150, the display 160, and the communication interface 170 to each other and for delivering communication (e.g., a control message and/or data) between the processor 120, the memory 130, the input/output interface 150, the display 160, and the communication interface 170.

The processor 120 may include one or more of a Central Processing Unit (CPU), an Application Processor (AP), and a Communication Processor (CP). The processor 120 may control, for example, at least one of the memory 130, the input/output interface 150, the display 160, and the communication interface 170 and/or may execute an arithmetic operation or data processing for communication. The processing (or controlling) operation of the processor 120 according to various embodiments is described in detail with reference to the following drawings.

The memory 130 may include a volatile and/or non-volatile memory. The memory 130 may store, for example, a command or data related to at least one different constitutional element of the vehicle computing device 101. In an example, the memory 130 may store a software and/or a program 140. The program 140 may include, for example, a kernel 141, a middleware 143, an Application Programming Interface (API) 145, and/or an application program (or an “application”) 147, or the like, configured for controlling one or more functions of the vehicle computing device 101 and/or an external device (e.g., the linear lighting devices 102 and/or the sensor devices 103). At least one part of the kernel 141, middleware 143, or API 145 may be referred to as an Operating System (OS). The memory 130 may include a computer-readable recording medium having a program recorded therein to perform the method according to various embodiments by the processor 120.

The kernel 141 may control or manage, for example, system resources (e.g., the bus 110, the processor 120, the memory 130, etc.) used to execute an operation or function implemented in other programs (e.g., the middleware 143, the API 145, or the application program 147). Further, the kernel 141 may provide an interface capable of controlling or managing the system resources by accessing individual constitutional elements of the vehicle computing device 101 in the middleware 143, the API 145, or the application program 147.

The middleware 143 may perform, for example, a mediation role so that the API 145 or the application program 147 can communicate with the kernel 141 to exchange data.

Further, the middleware 143 may handle one or more task requests received from the application program 147 according to a priority. For example, the middleware 143 may assign a priority of using the system resources (e.g., the bus 110, the processor 120, or the memory 130) of the vehicle computing device 101 to at least one of the application programs 147. For example, the middleware 143 may process the one or more task requests according to the priority assigned to at least one of the application programs, and thus, may perform scheduling or load balancing on the one or more task requests.

The API 145 may include at least one interface or function (e.g., instruction), for example, for file control, window control, video processing, or character control, as an interface capable of controlling a function provided by the application 147 in the kernel 141 or the middleware 143.

The application program 147 may include logic (e.g., hardware, software, firmware, etc.) that may be implemented to control the one or more linear lighting devices 102 to output one or more lighting patterns. The linear lighting devices 102 may be affixed to one or more locations of the vehicle. For example, the one or more locations may comprise one or more interior locations or one or more exterior locations such as a location adjacent to a front driver-side door of the vehicle, a location adjacent to a front passenger-side door of the vehicle, one or more locations within or adjacent to a windshield assembly of the vehicle, one or more locations of an instrument panel of the vehicle, one or more locations of a center console of the vehicle, and/or one or more locations of a bulkhead of the vehicle. In an example, the linear lighting devices 102 may be configured in a vertical configuration along one or more of a pillar between the front driver-side door and a front windshield of the vehicle or a pillar between the front passenger-side door and the front windshield. In an example, the linear lighting devices 102 may be configured in a horizontal configuration along one or more locations of the instrument panel. As an example, a linear lighting device 102 may comprise a strip of one or more LEDs. The application program 147 may be implemented to cause the vehicle computing device 101 to receive status information associated with the vehicle from one or more sensor devices 103. The sensor devices 103 may comprise a battery sensor, a fuel sensor, a GPS sensor, a temperature sensor, a speed sensor, a camera, or a Light Detection and Ranging (LiDAR) sensor, or combinations thereof. The status information may comprise a state of charge of a battery of the vehicle, remaining fuel of the vehicle, movement information of the vehicle, navigation information, seatbelt positions, position of one or more doors of the vehicle, incoming communication, heating and cooling information, or traffic information, or combinations thereof. The vehicle computing device 101 may determine one or more conditions associated with the vehicle based on the status information received from the one or more sensor devices 103. The one or more conditions may be associated with an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position, or combinations thereof. The vehicle computing device 101 may generate one or more signals for controlling the one or more linear lighting devices 102 to output one or more lighting patterns based on the one or more conditions. The vehicle computing device 101 may cause the one or more linear lighting devices to output the one or more lighting patterns based on the one or more signals. The one or more lighting patterns may comprise one or more of a flashing light pattern, a light pattern movement along a light beam path of at least one of the one or more linear lighting devices 102, a color pattern, or a brightness or dimming lighting pattern.

The input/output interface 150 may be configured as an interface for delivering an instruction or data input from a user or a different external device(s) to the processor 120, the memory 130, the input/output interface 150, the display 160, and the communication interface 170. Further, the input/output interface 150 may output an instruction or data received from the processor 120, the memory 130, the input/output interface 150, the display 160, and/or the communication interface 170 to a different external device.

The display 160 may include various types of displays, such as, for example, a Liquid Crystal Display (LCD) display, a Light Emitting Diode (LED) display, an Organic Light-Emitting Diode (OLED) display, a MicroElectroMechanical Systems (MEMS) display, or an electronic paper display. The display 160 may display, for example, a variety of contents (e.g., text, image, video, icon, symbol, etc.) to the user. The display 160 may include a touch screen. For example, the display 160 may receive a touch, gesture, proximity, or hovering input by using a stylus pen or a part of a user's body. In an example, the display 160 may comprise a visual interface for configuring the one or more lighting patterns. For example, the display 160 may output a preview of one or more configurations of the lighting patterns based on the one or more conditions.

The communication interface 170 may establish, for example, communication between the vehicle computing device 101 and an external device (e.g., the linear lighting devices 102, the sensor devices 103, or a server 106). For example, the communication interface 170 may communicate with the external device (e.g., the server 106) by being connected to a network 162 via wireless communication or wired communication. For example, as a cellular communication protocol, the wireless communication may use at least one of Long-Term Evolution (LTE), LTE Advance (LTE-A), Code Division Multiple Access (CDMA), Wideband CDMA (WCDMA), Universal Mobile Telecommunications System (UMTS), Wireless Broadband (WiBro), Global System for Mobile Communications (GSM), and the like. In an example, the network 162 may include, for example, at least one of a telecommunications network, a computer network (e.g., LAN or WAN), the internet, and a telephone network.

In addition, the communication interface 170 may communicate with the external device (e.g., the linear lighting devices 102 via communication path 164 and/or the sensor devices 103 via communication path 165) via wireless communication or wired communication. The wireless communication 164, 165 may include, for example, a near-distance communication. The near-distance communications 164, 165 may include, for example, at least one of Wireless Fidelity (WiFi), Bluetooth, Near Field Communication (NFC), Global Navigation Satellite System (GNSS), and the like. According to a usage region or a bandwidth or the like, the GNSS may include, for example, at least one of Global Positioning System (GPS), Global Navigation Satellite System (Glonass), Beidou Navigation Satellite System (hereinafter, “Beidou”), Galileo, the European global satellite-based navigation system, and the like. Hereinafter, the “GPS” and the “GNSS” may be used interchangeably in the present document. The wired communication 164, 165 may include, for example, at least one of Universal Serial Bus (USB), High Definition Multimedia Interface (HDMI), Recommended Standard-232 (RS-232), power-line communication, Plain Old Telephone Service (POTS), and the like.

The server 106 may comprise a group of one or more servers. In an example, all or some of the operations executed by the vehicle computing device 101 may be executed in a different one or a plurality of electronic devices (e.g., the linear lighting devices 102, the sensor devices 104, or the server 106). In an example, if the vehicle computing device 101 needs to perform a certain function or service either automatically or based on a request, the vehicle computing device 101 may request at least some parts of functions related thereto alternatively or additionally to a different electronic device (e.g., the linear lighting devices 102, the sensor devices 104, or the server 106) instead of executing the function or the service autonomously. The different electronic devices (e.g., the linear lighting devices 102, the sensor devices 104, or the server 106) may execute the requested function or additional function, and may deliver a result thereof to the vehicle computing device 101. The vehicle computing device 101 may provide the requested function or service either directly or by additionally processing the received result. For example, a cloud computing, distributed computing, or client-server computing technique may be used. In an example, the vehicle computing device 101 may receive sensor data (e.g., the status information) from the sensor devices 103 and output the sensor data to the server 106. The server 106 may be configured to process the sensor data to identify/determine one or more the one or more conditions associated with the vehicle. The server 106 may output the one or more signals to the vehicle computing device 101, wherein the vehicle computing device 101 may output the one or more signals to the linear lighting devices 102 to cause the linear lighting devices 102 to output the one or more lighting patterns.

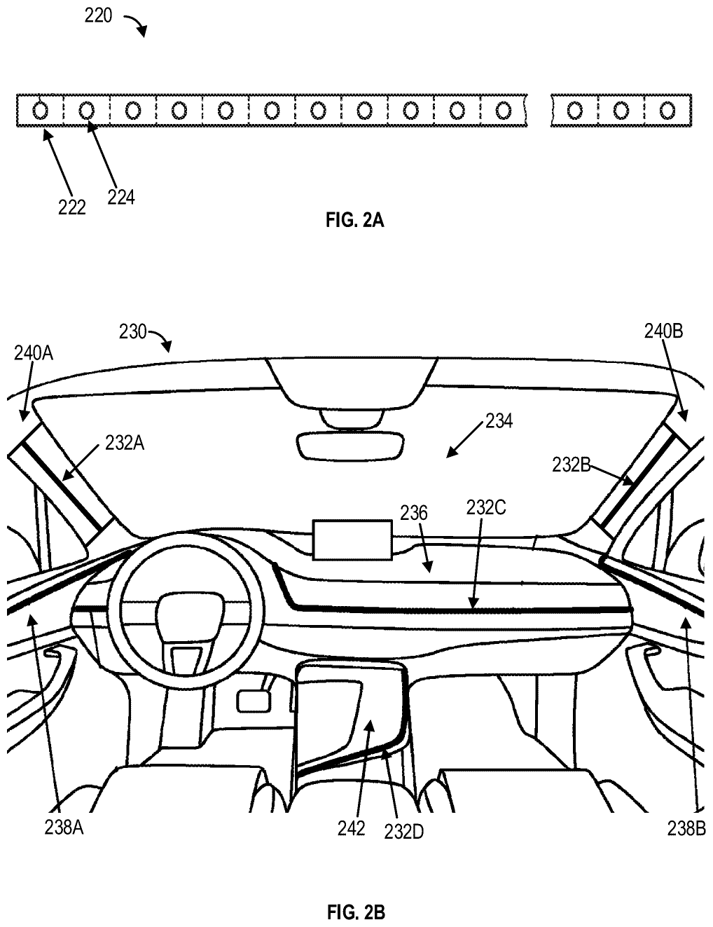

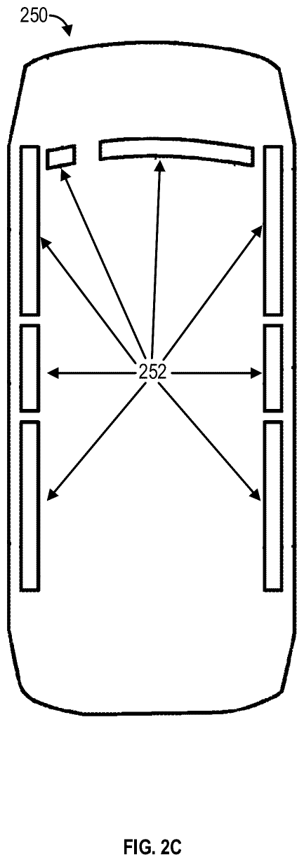

FIG. 2A shows an example linear lighting device 220. The linear lighting device 220 may comprise a plurality of lighting segments 222. Each lighting segment 222 may be separately controlled by the vehicle computing device 101. For example, the vehicle computing device 101 may control each lighting segment 222 to perform at least a portion of the one or more lighting patterns. For example, the one or more lighting patterns may comprise one or more of a flashing light pattern, a light pattern movement along a light beam path of at least one of the one or more linear lighting devices, a color pattern, or a brightness or dimming lighting pattern. Each lighting segment 222 may comprise at least one lighting element 224 (e.g., LED) that may be controlled by the vehicle computing device 101.

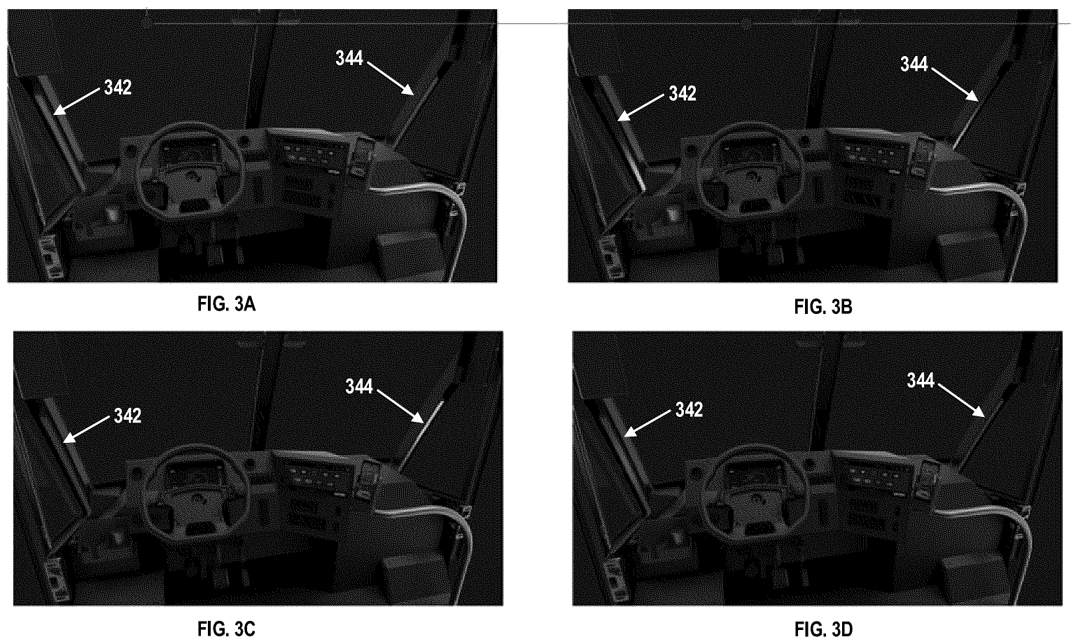

FIGS. 2B-2C show example systems configuration of one or more linear lighting devices affixed to one or more locations of a vehicle. FIG. 2B shows an example system configuration of one or more linear lighting devices 232A, 232B, 232C, 232D affixed to one or more locations within an interior of a vehicle 230. In an example, as shown in FIG. 2B, one or more linear lighting devices 232A, 232B, 232C, 232D may be affixed to a location adjacent to a front driver-side door of the vehicle, a location adjacent to a front passenger-side door of the vehicle, a location within or adjacent to a windshield assembly of the vehicle, one or more locations of an instrument panel of the vehicle, or one or more locations of a center console of the vehicle. A linear lighting device 232A may be configured in a vertical configuration along a pillar 240A between a front driver-side door 238A and a front windshield 234 of the vehicle 230. A linear lighting device 232B may be configured in a vertical configuration along a pillar 240B between a front passenger-side door 238B and the front windshield 234 of the vehicle 230. Optionally, in some aspects, the linear lighting devices 232A, 232B may be positioned in a vertical configuration at a pillar located in between respective sections of a windshield assembly (e.g., affixed to a portion of an A-pillar as shown in FIGS. 3A-3D). A linear lighting device 232C may be configured in a horizontal configuration along one or more locations of the instrument panel 236. A linear lighting device 232D may be affixed to a location of the center console 242. FIG. 2C shows an example system configuration of one or more linear lighting devices 252 affixed to one or more locations of a bulkhead of vehicle 250. In an example, as shown in FIG. 2C, the one or more linear lighting devices 252 may be affixed to different locations along the bulkhead.

FIGS. 3A-3D show example system configurations associated with one or more lighting patterns output via a first linear lighting device 342 and a second linear lighting device 344. In the exemplary configurations depicted in FIGS. 3A-3D, the first and second linear lighting devices 342, 344 are shown as affixed to or associated with pillars positioned in between respective sections of a windshield assembly of a vehicle (e.g., affixed to A-pillars of a windshield assembly of a delivery vehicle or work truck), such that the linear lighting devices are spaced inwardly from outermost lateral edges of the windshield assembly, thereby allowing for a driver of the vehicle to observe displayed light patterns while maintaining focus on a roadway and surrounding areas (through the windshield assembly). In an example, as shown in FIG. 3A, based on a condition associated with a rear door of the vehicle in an open position, the vehicle computing device 101 may cause the first linear lighting device 342 and the second linear lighting device 344 to output a solid light (e.g., red, green, blue, yellow, orange, etc.) across the length of each linear lighting device 342, 344. As an example, the vehicle computing device 101 may cause the linear lighting devices 342, 344 to flash the solid lights at a predetermined interval based on the rear door being left in the open position. In an example, as shown in FIG. 3B, based on a condition associated with another vehicle being detected in a blind spot of the vehicle, the vehicle computing device 101 may cause the linear lighting devices 342, 344 to output a solid light along only a portion of the length of the linear lighting devices 342, 344. As an example, the vehicle computing device 101 may cause the linear lighting devices 342, 344 to flash the lights along the portion of the length of the linear lighting devices 342, 344 for a predetermined interval. In an example, as shown in FIG. 3C, based on a condition associated with a state of charge of a battery of the vehicle, the vehicle computing device 101 may cause only one of the linear lighting devices 342, 344 to output a light along the length of one of the linear lighting devices 342, 344. As an example, the vehicle computing device 101 may cause one of the linear lighting devices 342, 344 to output a color gradient based on the state of charge of the battery. For example, a grown color may be output towards a top portion of one of the linear lighting devices 342, 344 (e.g., indicating a full charge), a yellow color may be output towards a middle portion of one of the linear lighting devices 342, 344 (e.g., indicating a medium charge), and a red color may be output towards a bottom portion of one of the linear lighting devices 342, 344 (e.g., indicating a low charge). As an example, the vehicle computing device 101 may cause one of the linear lighting devices 342, 344 to reduce the portion of the light according to the level of charge of the battery. As an example, the vehicle computing device 101 may cause one of the linear lighting devices 342, 344 to output a light pattern associated with a low state of charge of the battery. For example, one of the linear lighting devices 342, 344 may flash a portion of the linear lighting device 342, 344 at a predetermined interval indicating the low state of charge of the battery. In an example, as shown in FIG. 3D, based on a condition associated with an unbuckled seatbelt of the vehicle, the vehicle computing device 101 may cause only one of the linear lighting devices 342, 344 to output a light along a portion of one of the linear lighting devices 342, 344.

As an example, the vehicle computing device 101 may be configured to cause the linear lighting devices 342, 344 to output a plurality of lighting patterns associated with a plurality of conditions. For example, a different lighting pattern may be associated with each condition. For example, the lighting patterns may further include a light pattern movement along a light beam path of at least one of the one or more linear lighting devices 342, 344, a color pattern, or a brightness or dimming lighting pattern. In an example, the vehicle computing device 101 may include a GPS component. For example, the vehicle computing device 101 may use the GPS component to determine turn-by-turn guidance associated with a navigation route of the vehicle. Based on the navigation route, the vehicle computing device 101 may cause the linear lighting devices 342, 344 to output lighting patterns based on the turn-by-turn guidance associated with the navigation route. In one example, the linear lighting device 342 may be caused to output a lighting pattern based on a left turn indication. In addition, the linear lighting device 342 may be caused to output a lighting pattern associated with an indication of the vehicle's approach (e.g., distance) to the location for making the left turn. In another example, the linear lighting device 344 may be caused to output a lighting pattern based on a right turn indication. In addition, the linear lighting device 344 may be caused to output a lighting pattern associated with an indication of the vehicle's approach (e.g., distance) to the location for making the right turn. In an example, the vehicle computing device 101 may cause the linear lighting devices 342, 344 to output lighting patterns based on the heating, ventilation, and air conditioning system of the vehicle. For example, the vehicle computing device 101 may cause the linear lighting devices 342, 344 to output one or more patterns of blue light to indicate the interior is cooling down. For example, the vehicle computing device 101 may cause the linear lighting devices 342, 344 to output one or more patterns of red light to indicate the interior is heating up. In an example, the vehicle computing device 101 may cause the linear lighting devices 342, 344 to output lighting patterns to indicate one or more of a lane departure warning and/or a front collision warning.

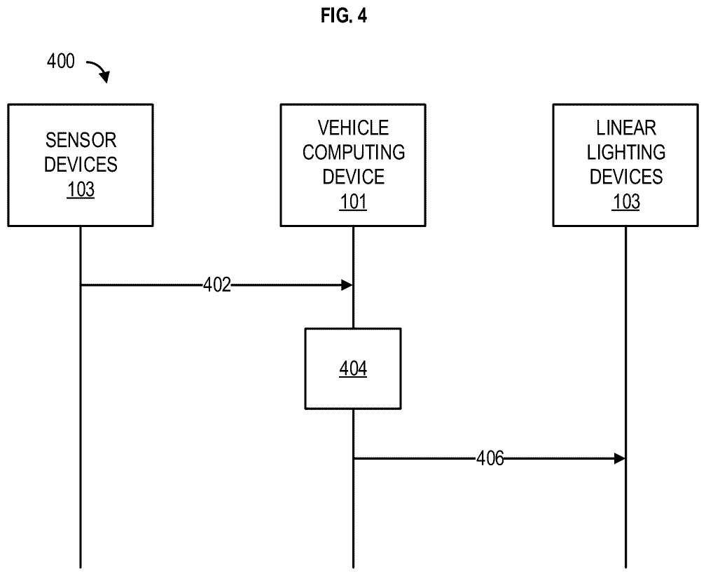

FIG. 4 shows a flowchart for an example process 400 for outputting one or more lighting patterns. The senor devices 103 may monitor one or more environments and/or systems associated with the vehicle. For example, the sensor devices 103 may comprise a battery sensor, a fuel sensor, a GPS sensor, a temperature sensor, a speed sensor, a camera, or a Light Detection and Ranging (LiDAR) sensor, or combinations thereof. At 402, the sensors devices 103 may provide status information to the vehicle computing device 101. For example, the battery sensor may provide information associated with a state of charge of the battery of the vehicle. The fuel sensor may provide information associated with a remaining amount of fuel of the vehicle. The GPS sensor may provide information associated with a location of the vehicle. One or more temperature sensors may be located at one or more interior and/or exterior locations of the vehicle, wherein the temperature sensors may provide information associated with temperatures of interior and exterior environments associated with the vehicle. The speed sensor may provide information associated with a current speed of the vehicle. The camera and/or the LiDAR sensors may provide information related to objects, such as trues, people, animals, etc., within an area of the vehicle. In an example, a camera may be affixed to an interior location of the vehicle. The camera may provide information related to the environment of the interior of the vehicle such as positions of one or more individuals in the vehicle, eye position of a driver of the vehicle, whether each individual in the vehicle is using a seatbelt, etc. At 404, the vehicle computing device 101 may determine one or more conditions associated with the vehicle based on the status information received from the sensor devices 103. For example, the one or more conditions may be associated with one or more of an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position. At 406, based on the one or more conditions, the vehicle computing device 101 may cause one or more linear lighting devices 103 to output one or more lighting patterns. For example, the one or more lighting patterns may comprise one or more of a flashing light pattern, a light pattern movement along a light beam path of at least one of the one or more linear lighting devices, a color pattern, or a brightness or dimming lighting pattern.

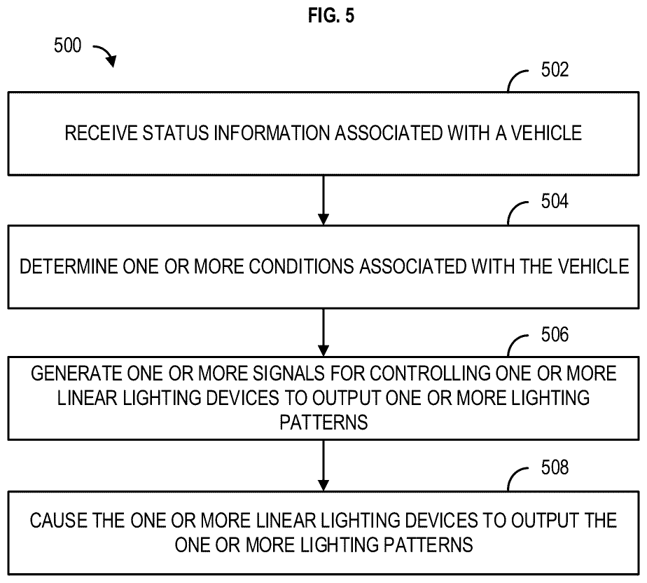

FIG. 5 shows a flowchart of an example method 500. The method 500 may be implemented by a computing device such as vehicle computing device 101, linear lighting devices 102, the sensors devices 104, combinations thereof, and the like. At step 502, a device (e.g., vehicle computing device 101) of a vehicle may receive status information associated with the vehicle from one or more sensors (e.g., sensor devices 103). The status information may comprise one or more of a state of charge of a battery of the vehicle, remaining fuel of the vehicle, movement information of the vehicle, navigation information, seatbelt positions, position of one or more doors of the vehicle, incoming communication, heating and cooling information, or traffic information. The one or more sensors may comprise a battery sensor, a fuel sensor, a GPS sensor, a temperature sensor, a speed sensor, a camera, or a Light Detection and Ranging (LiDAR) sensor, or combinations thereof.

At step 504, one or more conditions associated with the vehicle may be determined based on the status information received from the one or more sensors (e.g., sensor devices 103). For example, the one or more conditions associated with the vehicle may be determined by the device (e.g., vehicle computing device 101) based on the status information received from the one or more sensors. The one or more conditions may be associated with one or more of an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position.

At step 506, one or more signals for controlling the one or more linear lighting devices (e.g., linear lighting devices 102) to output one or more lighting patterns may be generated based on the one or more conditions. For example, the device (e.g., vehicle computing device 101) may generate the one or more signals for controlling the one or more linear lighting devices to output one or more lighting patterns based on the one or more conditions. Each linear lighting device of the one or more linear lighting devices may comprise a strip of one or more LEDs. The one or more linear lighting devices may be affixed to one or more locations of the vehicle. The one or more linear lighting devices may comprise one or more interior locations or one or more exterior locations, or combinations thereof. The one or more locations may comprise one or more of a location adjacent to a front driver-side door of the vehicle, a location adjacent to a front passenger-side door of the vehicle, one or more locations within or adjacent to a windshield assembly of the vehicle, one or more locations of an instrument panel of the vehicle, one or more locations of a center console of the vehicle, or one or more locations of a bulkhead of the vehicle. In an example, the one or more linear lighting devices may be configured in a vertical configuration along one or more of a pillar between the front driver-side door and a front windshield of the vehicle or a pillar between the front passenger-side door and the front windshield. In an example, the one or more linear lighting devices may be configured in a horizontal configuration along one or more locations of the instrument panel.

At step 508, the one or more linear lighting devices (e.g., linear lighting devices 102) may be caused to output the one or more lighting patterns based on the one or more signals. For example, the device (e.g., vehicle computing device 101) may cause the one or more linear lighting devices to output the one or more lighting patterns based on the one or more signals. The one or more lighting patterns may comprise one or more of a flashing light pattern, a light pattern movement along a light beam path of at least one of the one or more linear lighting devices, a color pattern, or a brightness or dimming lighting pattern.

For purposes of illustration, application programs and other executable program components are illustrated herein as discrete blocks, although it is recognized that such programs and components can reside at various times in different storage components. An implementation of the described methods can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” can comprise volatile and non-volatile, removable and non-removable media implemented in any methods or technology for storage of information such as computer readable instructions, data structures, program modules, or other data. Exemplary computer storage media can comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The present disclosure relates to vehicle lighting systems and methods for controlling vehicle lighting based on various conditions. The vehicle lighting system described herein may provide enhanced functionality and improved communication of vehicle status and operational information through the use of configurable lighting patterns. By integrating sensor data and vehicle status information with controllable linear lighting devices, the system may convey important information to vehicle occupants and nearby individuals in an intuitive and visually appealing manner. The lighting system may be adaptable to various vehicle types and configurations, allowing for customized implementations across different vehicle models and use cases. Through the dynamic control of lighting patterns, colors, and intensities, the system may enhance safety, improve user experience, and provide valuable visual cues related to vehicle operation and surrounding conditions.

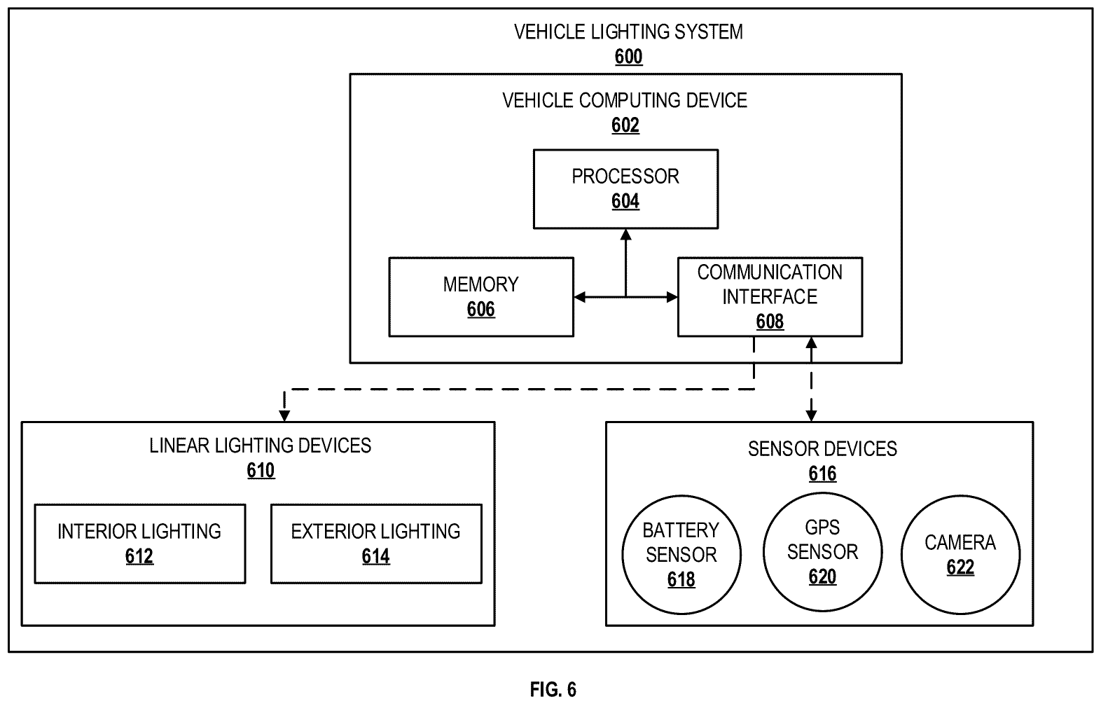

FIG. 6 shows a block diagram of a vehicle lighting system 600. The vehicle lighting system 600 may include a vehicle computing device 602. The vehicle computing device 602 may be configured to control various components of the vehicle lighting system 600. The vehicle computing device 602 may include a processor 604, a memory 606, and a communication interface 608. These components may be interconnected to enable the vehicle computing device 602 to perform various functions related to condition-based lighting control.

The processor 604 may be included in the vehicle computing device 602. The processor 604 may be configured to execute instructions stored in the memory 606 and process data related to the vehicle's status and conditions. In some cases, the processor 604 may analyze sensor data, determine vehicle conditions, and generate control signals for the linear lighting devices.

The vehicle computing device 602 may include a memory 606. The memory 606 may store instructions, data, and programs that may be executed by the processor 604. In some cases, the memory 606 may store predefined lighting patterns associated with various vehicle conditions, allowing for quick retrieval and implementation of appropriate lighting responses.

The communication interface 608 may be included in the vehicle computing device 602. The communication interface 608 may enable the vehicle computing device 602 to communicate with other components of the vehicle lighting system 600, such as one or more sensor devices 616 and one or more linear lighting devices 610. In some cases, the communication interface 608 may receive status information from the one or more sensor devices 616 and transmit control signals to the one or more linear lighting devices 610.

The vehicle computing device 602 may contribute to the technological solution of condition-based lighting control by processing sensor data, determining vehicle conditions, and generating appropriate lighting patterns. For example, the processor 604 may analyze battery sensor data to determine a low state of charge condition. Based on this condition, the vehicle computing device 602 may generate control signals for the one or more linear lighting devices 610 to display a specific lighting pattern indicating the low battery status.

In some cases, the vehicle computing device 602 may use the communication interface 608 to receive GPS data and determine the vehicle's current location and navigation route. The processor 604 may then generate lighting patterns to indicate upcoming turns or other navigation instructions, which may be displayed through the one or more linear lighting devices 610.

The memory 606 of the vehicle computing device 602 may store a database of lighting patterns associated with various vehicle conditions. This may allow for efficient and consistent lighting responses to different scenarios, enhancing the overall functionality of the condition-based lighting control system.

The vehicle lighting system 600 may include one or more linear lighting devices 610. The one or more linear lighting devices 610 may be configured to output various lighting patterns based on control signals received from the vehicle computing device 602. In some cases, the one or more linear lighting devices 610 may comprise interior lighting 612 and exterior lighting 614.

The interior lighting 612 may be positioned within the vehicle cabin to provide visual information to vehicle occupants. In some cases, the interior lighting 612 may be installed along the vehicle's A-pillars, instrument panel, or center console. The interior lighting 612 may contribute to the technological solution by displaying lighting patterns related to vehicle status, navigation instructions, or safety alerts directly within the driver's field of view.

The exterior lighting 614 may be positioned on the vehicle's exterior surfaces to communicate information to individuals outside the vehicle. In some cases, the exterior lighting 614 may be installed along the vehicle's body panels, near door handles, or integrated into the vehicle's existing lighting fixtures. The exterior lighting 614 may contribute to the technological solution by providing visual cues about the vehicle's status or intentions to pedestrians, other drivers, or individuals approaching the vehicle.

The one or more linear lighting devices 610 may comprise strips of light-emitting diodes (LEDs) that can be individually controlled to create various lighting patterns. In some cases, the one or more linear lighting devices 610 may be capable of displaying different colors, intensities, and dynamic lighting effects. This versatility may allow the vehicle lighting system 600 to convey a wide range of information through visual cues.

The processor 604 of the vehicle computing device 602 may generate control signals for the one or more linear lighting devices 610 based on the determined vehicle conditions. These control signals may be transmitted to the one or more linear lighting devices 610 through the communication interface 608. In some cases, the memory 606 may store predefined lighting patterns associated with specific vehicle conditions, allowing the processor 604 to quickly retrieve and implement appropriate lighting responses.

The one or more linear lighting devices 610 may contribute to the technological solution of condition-based lighting control by providing a flexible and intuitive means of conveying information. For example, the interior lighting 612 may display a pulsing red pattern to indicate a low battery condition, while the exterior lighting 614 may show a sequential lighting pattern to indicate an upcoming turn based on navigation data.

In some cases, the one or more linear lighting devices 610 may be programmed to display different patterns or colors based on the severity or urgency of a detected condition. This may allow the vehicle lighting system 600 to prioritize and effectively communicate multiple pieces of information simultaneously, enhancing the overall functionality of the condition-based lighting control system.

The vehicle lighting system 600 may include one or more sensor devices 616. The one or more sensor devices 616 may be configured to gather various types of status information related to the vehicle and its surroundings. This status information may be used by the vehicle computing device 602 to determine vehicle conditions and generate appropriate lighting patterns.

In some cases, the one or more sensor devices 616 may include a battery sensor 618. The battery sensor 618 may be configured to monitor the state of charge of the vehicle's battery. For example, the battery sensor 618 may provide information about a current charge level, voltage, or overall health of the battery. This information may be transmitted to the vehicle computing device 602 through the communication interface 608.

The one or more sensor devices 616 may also include a GPS sensor 620. The GPS sensor 620 may be used to determine the vehicle's current location, speed, and direction of travel. In some cases, the GPS sensor 620 may work in conjunction with navigation software stored in the memory 606 to provide route information and upcoming turn notifications.

A camera 622 may be included as part of the one or more sensor devices 616. The camera 622 may be positioned to capture images or video of the vehicle's surroundings. In some cases, multiple cameras may be installed at various locations around the vehicle to provide a comprehensive view of the environment. The camera 622 may contribute to the technological solution by providing visual data that can be analyzed by the processor 604 to detect obstacles, pedestrians, or other relevant information.

The one or more sensor devices 616 may transmit the gathered status information to the vehicle computing device 602 through the communication interface 608. The processor 604 may then analyze this information to determine various vehicle conditions. For example, the processor 604 may use data from the battery sensor 618 to identify a low battery condition, or data from the GPS sensor 620 to determine when the vehicle is approaching a turn in its navigation route.

In some cases, the one or more sensor devices 616 may include additional types of sensors not explicitly shown in FIG. 6. These may include temperature sensors for monitoring interior and exterior temperatures, fuel level sensors, door position sensors, or occupancy sensors for detecting the presence and position of vehicle occupants.

The data collected by the one or more sensor devices 616 may be used by the vehicle computing device 602 to generate appropriate control signals for the linear lighting devices 610. For instance, if the battery sensor 618 indicates a low charge state, the processor 604 may generate a control signal to cause the interior lighting 612 to display a specific color or pattern indicating the low battery condition to the vehicle occupants.

Similarly, data from the GPS sensor 620 may be used to trigger navigation-related lighting patterns. For example, as the vehicle approaches a turn indicated by the navigation system, the processor 604 may generate control signals to cause the exterior lighting 614 to display a sequential lighting pattern indicating the upcoming turn direction.

The camera 622 may provide visual data that can be processed to detect potential hazards or obstacles. In some cases, if an obstacle is detected, the processor 604 may generate control signals to cause the one or more linear lighting devices 610 to display warning patterns or colors, alerting the driver to the potential danger.

By integrating data from multiple sensor devices 616, the vehicle lighting system 600 may provide a comprehensive and responsive lighting control system. This integration may allow for dynamic and context-aware lighting patterns that effectively communicate various vehicle conditions and environmental information to both vehicle occupants and individuals outside the vehicle.

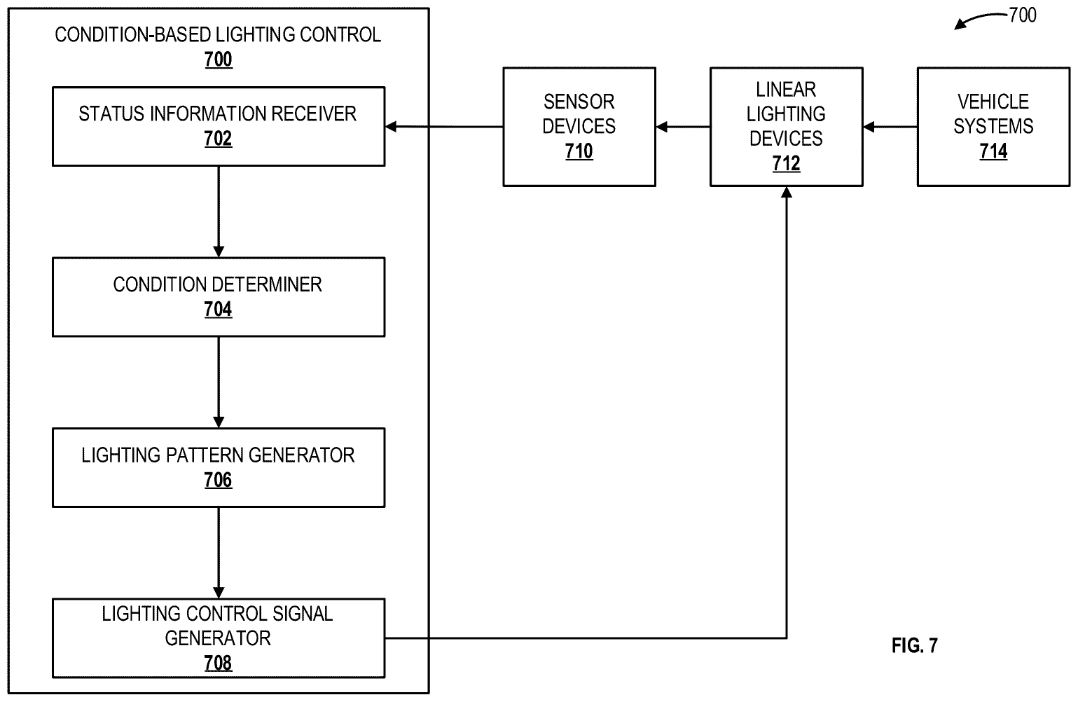

FIG. 7 shows a block diagram of a lighting control system 700. The lighting control system 700 may be a component of the vehicle lighting system 600 and may be implemented within the vehicle computing device 602. The lighting control system 700 may include several interconnected components that work together to process information and generate appropriate lighting patterns for the linear lighting devices 610.

A status information receiver 702 may be included in the lighting control system 700. The status information receiver 702 may be configured to receive status information from the one or more sensor devices 616. In some cases, the status information receiver 702 may interface with the communication interface 608 to gather data from various sensors, such as the battery sensor 618 and the camera 622. The status information receiver 702 may contribute to the technological solution by collecting and organizing diverse sensor data for further processing.

The lighting control system 700 may include a condition determiner 704. The condition determiner 704 may be connected to the status information receiver 702 and may receive the collected sensor data. In some cases, the condition determiner 704 may analyze the received status information to identify specific vehicle conditions or situations. For example, the condition determiner 704 may process data from the battery sensor 618 to determine if the vehicle's battery charge is low. The condition determiner 704 may contribute to the technological solution by interpreting raw sensor data and translating it into meaningful vehicle conditions that may require specific lighting responses.

A lighting pattern generator 706 may be included in the lighting control system 700. The lighting pattern generator 706 may be connected to the condition determiner 704 and may receive information about the identified vehicle conditions. In some cases, the lighting pattern generator 706 may access predefined lighting patterns stored in the memory 606 that correspond to specific vehicle conditions. The lighting pattern generator 706 may select or create appropriate lighting patterns based on the determined conditions. For example, if the condition determiner 704 identifies a low battery condition, the lighting pattern generator 706 may select a pulsing red light pattern to indicate this status.

The lighting control system 700 may include a lighting control signal generator 708. The lighting control signal generator 708 may be connected to the lighting pattern generator 706 and may receive the selected or created lighting patterns. In some cases, the lighting control signal generator 708 may translate the lighting patterns into specific control signals that can be interpreted by the linear lighting devices 610. These control signals may specify parameters such as color, intensity, duration, and sequence of lighting effects. The lighting control signal generator 708 may contribute to the technological solution by converting abstract lighting patterns into concrete instructions for the linear lighting devices 610.

In some cases, the lighting control system 700 may operate in a continuous loop, constantly receiving and processing new status information from the sensor devices 616. This may allow the system to dynamically update lighting patterns in response to changing vehicle conditions. For example, as the vehicle's battery charge level changes, the lighting control system 700 may adjust the displayed lighting pattern accordingly.

The processor 604 of the vehicle computing device 602 may execute instructions stored in the memory 606 to implement the functions of the various components of the lighting control system 700. In some cases, the processor 604 may perform real-time calculations and decision-making processes to ensure timely and appropriate lighting responses to vehicle conditions.

The lighting control system 700 may interface with both the interior lighting 612 and exterior lighting 614 components of the linear lighting devices 610. This may allow the system to provide visual information to both vehicle occupants and individuals outside the vehicle. For example, a low battery condition may be indicated through interior lighting patterns visible to the driver, while navigation-related lighting patterns may be displayed through exterior lighting to communicate the vehicle's intentions to other road users.

By integrating multiple components that process and transform sensor data into meaningful lighting patterns, the lighting control system 700 may provide a comprehensive solution for condition-based vehicle lighting control. This system may enhance vehicle safety, improve user experience, and facilitate more effective communication of vehicle status and intentions through dynamic lighting displays.

The vehicle lighting system 600 may integrate various components to perform condition-based lighting control, resulting in a technological improvement in vehicle communication and safety. The interaction between these components may enable the system to dynamically respond to changing vehicle conditions and provide intuitive visual information to both vehicle occupants and external observers.

In some cases, the sensor devices 616 may gather status information about the vehicle and its surroundings. For example, the battery sensor 618 may monitor the vehicle's battery charge level, while the camera 622 may capture visual data of the vehicle's environment. This status information may be transmitted to the vehicle computing device 602 through the communication interface 608.

The vehicle computing device 602 may process the received status information using the lighting control system 700. The status information receiver 702 may collect and organize the data from various sensor devices 616. The condition determiner 704 may then analyze this data to identify specific vehicle conditions that may require a lighting response.

Based on the determined conditions, the lighting pattern generator 706 may select or create appropriate lighting patterns. These patterns may be translated into specific control signals by the lighting control signal generator 708. The control signals may then be sent to the linear lighting devices 610 through the communication interface 608.

The one or more linear lighting devices 610, which may include interior lighting 612 and exterior lighting 614, may respond to these control signals by displaying the specified lighting patterns. For example, if the condition determiner 704 identifies a low battery condition based on data from the battery sensor 618, the lighting pattern generator 706 may select a pulsing red light pattern. The lighting control signal generator 708 may then create the necessary control signals to cause the interior lighting 612 to display this pattern, alerting the vehicle occupants to the low battery status.

In some cases, the processor 604 may execute instructions stored in the memory 606 to coordinate these interactions. The processor 604 may perform real-time calculations and decision-making processes to ensure timely and appropriate lighting responses to changing vehicle conditions.

The technological improvement resulting from this interaction may be evident in several ways. For example, the system may provide more immediate and intuitive communication of vehicle status compared to traditional dashboard indicators. The use of dynamic lighting patterns may allow for a wider range of information to be conveyed, potentially improving driver awareness and decision-making.

Furthermore, the integration of exterior lighting 614 into the system may enhance communication with other road users. For example, the lighting control system 700 may use data from the camera 622 to detect an approaching vehicle in a blind spot. In response, the exterior lighting 614 may display a warning pattern, potentially reducing the risk of collisions.

The vehicle lighting system 600 may also interface with vehicle systems 714. In some cases, the vehicle systems 714 may provide additional status information or receive commands based on the lighting control system's output. For example, if the lighting control system 700 determines a low battery condition, it may not only display a warning through the linear lighting devices 610 but also send a signal to the vehicle systems 714 to activate power-saving measures.

By continuously processing sensor data and adjusting lighting patterns in real-time, the vehicle lighting system 600 may provide a more responsive and adaptive communication system compared to traditional static indicator lights. This dynamic approach may contribute to improved vehicle safety, enhanced user experience, and more effective communication of vehicle status and intentions.

Embodiment 1: A vehicle lighting system comprising: one or more linear lighting devices affixed to one or more locations of the vehicle, one or more sensor devices affixed to the vehicle, wherein the one or more sensor devices are configured to determine status information associated with the vehicle, a computing device in communication with the one or more linear lighting devices and the one or more sensor devices, wherein the computing device is configured to receive the status information, determine, based on the status information, one or more conditions associated with the vehicle, generate, based on the one or more conditions, one or more signals for controlling the one or more linear lighting devices to output one or more lighting patterns, and cause, based on the one or more signals, the one or more linear lighting devices to output the one or more lighting patterns.

Embodiment 2: The embodiment as in any one of the preceding embodiments, wherein the one or more locations comprise one or more interior locations.

Embodiment 3: The embodiment as in any one of the preceding embodiments, wherein the one or more locations comprise a location adjacent to a front driver-side door of the vehicle, a location adjacent to a front passenger-side door of the vehicle, one or more locations within a windshield assembly of the vehicle, one or more locations of an instrument panel of the vehicle, one or more locations of a center console of the vehicle, or one or more locations of a bulkhead of the vehicle, or combinations thereof.

Embodiment 4: The embodiment as in the embodiment 4, wherein the one or more linear lighting devices are configured in a vertical configuration along one or more of a pillar between the front driver-side door and a front windshield of the vehicle, a pillar between respective sections of a windshield assembly of the vehicle, or a pillar between the front passenger-side door and the front windshield.

Embodiment 5: The embodiment as in the embodiment 4, wherein the one or more linear lighting devices are affixed to an A-pillar of a windshield assembly of the vehicle.

Embodiment 6: The embodiment as in the embodiment 3, wherein the one or more linear lighting devices are configured in a horizontal configuration along one or more locations of the instrument panel.

Embodiment 7: The embodiment as in any one of the preceding embodiments, wherein each linear lighting device of the one or more linear lighting devices comprises a strip of one or more LEDs.

Embodiment 8: The embodiment as in any one of the preceding embodiments, wherein the one or more lighting patterns comprise one or more of a flashing light pattern, a light pattern movement along a light beam path of at least one of the one or more linear lighting devices, a color pattern, or a brightness or dimming lighting pattern.

Embodiment 9: The embodiment as in any one of the preceding embodiments, wherein the one or more sensor devices comprise a battery sensor, a fuel sensor, a GPS sensor, a temperature sensor, a speed sensor, a camera, or a Light Detection and Ranging (LiDAR) sensor, or combinations thereof.

Embodiment 10: The embodiment as in any one of the preceding embodiments, wherein the status information comprises a state of charge of a battery of the vehicle, remaining fuel of the vehicle, movement information of the vehicle, navigation information, seatbelt positions, position of one or more doors of the vehicle, incoming communication, heating and cooling information, or traffic information, or combinations thereof.

Embodiment 11: The embodiment as in any one of the preceding embodiments, wherein the one or more conditions are associated with one or more of an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position.

Embodiment 12: A lighting control system for a vehicle comprising: a status information receiver configured to receive status information from one or more sensor devices associated with the vehicle, a condition determiner configured to determine one or more conditions associated with the vehicle based on the received status information, a lighting pattern generator configured to generate one or more lighting patterns based on the determined one or more conditions, and a lighting control signal generator configured to generate one or more control signals for controlling one or more linear lighting devices to output the one or more lighting patterns.

Embodiment 13: The embodiment as in the embodiment 12, wherein the one or more sensor devices comprise one or more of: a battery sensor, a fuel sensor, a GPS sensor, a temperature sensor, a speed sensor, a camera, or a Light Detection and Ranging (LiDAR) sensor.

Embodiment 14: The embodiment as in any one of the embodiments 12-13, wherein the status information comprises at least one of: a state of charge of a battery of the vehicle, remaining fuel of the vehicle, movement information of the vehicle, navigation information, seatbelt positions, position of one or more doors of the vehicle, incoming communication, heating and cooling information, or traffic information.

Embodiment 15: The embodiment as in any one of the embodiments 12-14, wherein the one or more conditions are associated with one or more of: an advanced driver assistance system (ADAS), one or more unsecured seatbelts, a navigation route of the vehicle, a steering direction, a low state of charge of a battery of the vehicle, a low amount of fuel remaining, a heating or cooling setting of the vehicle, a parked position of the vehicle, or one or more open doors.

Embodiment 16: The embodiment as in any one of the embodiments 12-15, wherein the one or more lighting patterns comprise one or more of: a flashing light pattern, a light pattern movement along a light beam path of at least one of the one or more linear lighting devices, a color pattern, or a brightness or dimming lighting pattern.

Embodiment 17: The embodiment as in the embodiment 16, wherein the lighting pattern generator is configured to select the one or more lighting patterns from a database of predefined lighting patterns stored in a memory of the lighting control system.

Embodiment 18: The embodiment as the embodiment 17, wherein the lighting control signal generator is configured to translate the selected one or more lighting patterns into specific control signals that specify parameters including color, intensity, duration, and sequence of lighting effects for the one or more linear lighting devices.

Embodiment 19: A method comprising: receiving, by a device of a vehicle, from one or more sensors of the vehicle, status information associated with the vehicle, determining, based on the status information received from the one or more sensors, one or more conditions associated with the vehicle, generating, based on the one or more conditions, one or more signals for controlling one or more linear lighting devices to output one or more lighting patterns, and causing, based on the one or more signals, the one or more linear lighting devices to output the one or more lighting patterns.

Embodiment 20: The embodiment as in the embodiment 19, wherein the one or more sensors comprise one or more of a battery sensor, a fuel sensor, a GPS sensor, a temperature sensor, a speed sensor, a camera, or a Light Detection and Ranging (LiDAR) sensor, or combinations thereof.

Embodiment 21: The embodiment as in any one of the embodiments 19-20, wherein the status information comprises one or more of a state of charge of a battery of the vehicle, remaining fuel of the vehicle, movement information of the vehicle, navigation information, seatbelt positions, position of one or more doors of the vehicle, incoming communication, heating and cooling information, or traffic information.

Embodiment 22: The embodiment as in any one of the embodiments 19-21, wherein the one or more conditions are associated with one or more of an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position.

Embodiment 23: The embodiment as in any one of the embodiments 19-22, wherein the one or more linear lighting devices are affixed to one or more interior locations of the vehicle.

Embodiment 24: The embodiment as in the embodiment 23, wherein the one or more interior locations comprise a location adjacent to a front driver-side door of the vehicle, a location adjacent to a front passenger-side door of the vehicle, one or more locations within a windshield assembly of the vehicle, one or more locations of an instrument panel of the vehicle, one or more locations of a center console of the vehicle, or one or more locations of a bulkhead of the vehicle, or combinations thereof.

Embodiment 25: The embodiment as in the embodiment 24, wherein the one or more linear lighting devices are configured in a vertical configuration along one or more of a pillar between the front driver-side door and a front windshield of the vehicle, a pillar between respective sections of a windshield assembly of the vehicle, or a pillar between the front passenger-side door and the front windshield.

Embodiment 26: The embodiment as in the embodiment 24, wherein the one or more linear lighting devices are configured in a horizontal configuration along one or more locations of the instrument panel.

Embodiment 27: The embodiment as in any one of the embodiments 19-26, wherein the one or more lighting patterns comprise one or more of a flashing light pattern, a light pattern movement along a light beam path of at least one of the one or more linear lighting devices, a color pattern, or a brightness or dimming lighting pattern.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

The invention claimed is:

1. A vehicle lighting system comprising:
one or more linear lighting devices affixed to one or more locations of the vehicle;
one or more sensor devices affixed to the vehicle, wherein the one or more sensor devices are configured to determine status information associated with the vehicle;
a computing device in communication with the one or more linear lighting devices and the one or more sensor devices, wherein the computing device is configured to:
receive the status information;
determine, based on the status information, one or more conditions associated with the vehicle;
generate, based on the one or more conditions, one or more signals for controlling the one or more linear lighting devices to output one or more lighting patterns; and
cause, based on the one or more signals, the one or more linear lighting devices to output the one or more lighting patterns.

2. The vehicle of claim 1, wherein the one or more locations comprise one or more interior locations.

3. The vehicle of claim 1, wherein the one or more locations comprise a location adjacent to a front driver-side door of the vehicle, a location adjacent to a front passenger-side door of the vehicle, one or more locations within a windshield assembly of the vehicle, one or more locations of an instrument panel of the vehicle, one or more locations of a center console of the vehicle, or one or more locations of a bulkhead of the vehicle, or combinations thereof.

4. The vehicle of claim 3, wherein the one or more linear lighting devices are configured in a vertical configuration along one or more of a pillar between the front driver-side door and a front windshield of the vehicle, a pillar between respective sections of a windshield assembly of the vehicle, or a pillar between the front passenger-side door and the front windshield.

5. The vehicle of claim 4, wherein the one or more linear lighting devices are affixed to an A-pillar of a windshield assembly of the vehicle.

6. The vehicle of claim 3, wherein the one or more linear lighting devices are configured in a horizontal configuration along one or more locations of the instrument panel.

7. The vehicle of claim 1, wherein each linear lighting device of the one or more linear lighting devices comprises a strip of one or more LEDs.

8. The vehicle of claim 1, wherein the one or more lighting patterns comprise one or more of a flashing light pattern, a light pattern movement along a light beam path of at least one of the one or more linear lighting devices, a color pattern, or a brightness or dimming lighting pattern.

9. The vehicle of claim 1, wherein the one or more sensor devices comprise a battery sensor, a fuel sensor, a GPS sensor, a temperature sensor, a speed sensor, a camera, or a Light Detection and Ranging (LiDAR) sensor, or combinations thereof.

10. The vehicle of claim 1, wherein the status information comprises a state of charge of a battery of the vehicle, remaining fuel of the vehicle, movement information of the vehicle, navigation information, seatbelt positions, position of one or more doors of the vehicle, incoming communication, heating and cooling information, or traffic information, or combinations thereof.

11. The vehicle of claim 1, wherein the one or more conditions are associated with one or more of an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position.

12. A method comprising:
receiving, by a device of a vehicle, from one or more sensors of the vehicle, status information associated with the vehicle;
determining, based on the status information received from the one or more sensors, one or more conditions associated with the vehicle;
generating, based on the one or more conditions, one or more signals for controlling one or more linear lighting devices to output one or more lighting patterns; and
causing, based on the one or more signals, the one or more linear lighting devices to output the one or more lighting patterns.

13. The method of claim 12, wherein the one or more sensors comprise one or more of a battery sensor, a fuel sensor, a GPS sensor, a temperature sensor, a speed sensor, a camera, or a Light Detection and Ranging (LiDAR) sensor, or combinations thereof.

14. The method of claim 12, wherein the status information comprises one or more of a state of charge of a battery of the vehicle, remaining fuel of the vehicle, movement information of the vehicle, navigation information, seatbelt positions, position of one or more doors of the vehicle, incoming communication, heating and cooling information, or traffic information.

15. The method of claim 12, wherein the one or more conditions are associated with one or more of an advanced car alert system (ADAS), one or more seatbelts are not in a secure position, a navigation route of the vehicle to a destination, a steering direction, a low state of charge of a battery of the vehicle, a low amount of fuel remaining, a heating or cooling setting of the vehicle, the vehicle is in a parked position, or one or more doors are in an open position.

16. The method of claim 12, wherein the one or more linear lighting devices are affixed to one or more interior locations of the vehicle.

17. The method of claim 16, wherein the one or more interior locations comprise a location adjacent to a front driver-side door of the vehicle, a location adjacent to a front passenger-side door of the vehicle, one or more locations within a windshield assembly of the vehicle, one or more locations of an instrument panel of the vehicle, one or more locations of a center console of the vehicle, or one or more locations of a bulkhead of the vehicle, or combinations thereof.

18. The method of claim 17, wherein the one or more linear lighting devices are configured in a vertical configuration along one or more of a pillar between the front driver-side door and a front windshield of the vehicle, a pillar between respective sections of a windshield assembly of the vehicle, or a pillar between the front passenger-side door and the front windshield.

19. The method of claim 17, wherein the one or more linear lighting devices are configured in a horizontal configuration along one or more locations of the instrument panel.

20. The method of claim 12, wherein the one or more lighting patterns comprise one or more of a flashing light pattern, a light pattern movement along a light beam path of at least one of the one or more linear lighting devices, a color pattern, or a brightness or dimming lighting pattern.
